(19) United States
(12) Patent Application Publication
(10) Pub. No.: US 2012/0054005 A1
(43) Pub. Date: Mar. 1, 2012

(54) LOCATION BASED ELECTRONIC READER SERVICES FOR WAITING ROOMS

(76) Inventors: Gregory P. Manning, New York, NY (US); Antonio Papageorgiou, Bronx, NY (US)

(21) Appl. No.: 13/053,163

(22) Filed: Mar. 21, 2011

Related U.S. Application Data
(60) Provisional application No. 61/315,916, filed on Mar. 20, 2010.
(60) Provisional application No. 61/328,263, filed on Apr. 27, 2010.

(51) Int. Cl. G06F 21/24; G06Q 30/02

(52) U.S. Cl. 705/14.4; 726/29

(57) ABSTRACT

In at least one embodiment, a system that is operable for receiving a request for an electronic file in an ebook format from a recipient user of at least one of the ebook readers; determining a location of the at least one ebook reader and a time of the request for the file; determining that the location and the time of the request is within a location and time specified by a subscriber other than the user; and providing access to the file based on the location and the time of the request.

The present application claims priority to Provisional Application No. 61/315,916 filed Mar. 20, 2011 and Provisional Application No. 61/328,263 filed Apr. 27, 2010, which hereby are incorporated herein by reference.

### BACKGROUND

The present application relates to eBook readers and eBook related services.

EBooks have grown in popularity and there are currently a number of services for users to download eBooks directly to the reader. Current eBook services, however, do not allow users to use other owner's eBooks, for example, for a limited time or within a limited area. This necessarily means that owners of certain written material that provide it to their customers, such as in waiting rooms, must provide the written material in hard copy format. Accordingly, there is a need for methods and systems for providing eBooks that are limited geographically and/or temporally.

### SUMMARY OF THE INVENTION

In at least one embodiment, a system is provided that comprises at least one computing device coupled over a network to a plurality of ebook readers, the at least one computing device having software associated therewith that when executed causes the at least one computing device to perform a method comprising: receiving a request for an electronic file in an ebook format from a recipient user of at least one of the ebook readers; determining a location of the at least one ebook reader and a time of the request for the file; determining that the location and the time of the request is within a location and time specified by a subscriber other than the user; and providing access to the file based on the location and the time of the request.

In at least one embodiment, the method comprises determining that the device has moved out of the location specified by the subscriber and blocking access to the file in response thereto.

In at least one embodiment, the method comprises determining that the device has moved out of the location specified by the subscriber and blocking access to the file in response thereto a predetermined time after the device has moved out of the location.

In at least one embodiment, the method comprises communicating an offer to the user of the device to subscribe to the file.

In at least one embodiment, the subscriber provides a service at the location and the recipient user is provided access to the file in conjunction with the service.

In at least one embodiment, the ebook is a magazine.

In at least one embodiment, the ebook is a pamphlet relevant to the service provided by the subscriber.

In at least one embodiment, location is determined based on a key made available at the location.

In at least one embodiment, the subscriber provides a unique key for each of a plurality of users.

In at least one embodiment, the user has an appointment for a service provided by the subscriber and the file is made available within a period of time before and after the appointment.

### DESCRIPTION OF THE INVENTION

The present application therefore provides methods and systems that provide eBooks and other electronic media files that are limited in at least one way, such as geographically, temporally, etc. This beneficially allows written and other material in electronic format or eBooks, such as books, periodicals, pamphlets, etc., to be shared with others without necessarily allowing the recipients to take the eBook with them. Professionals that provide written material for their customers to peruse while in their waiting room can therefore reduce the clutter typically found in their waiting rooms by providing eBooks limited in the manner discussed herein. eBook and other media file providers are also provided with an additional venue for their eBooks and advertisements therein.

These limits to eBooks can be accomplished in a variety of ways. In terms of the system, all that is needed is an eBook reader connected over a communication network to an eBook provider and/or a subscriber. Although the system and process may be discussed by way of example in relation to eBooks and eBook readers, it is understood that the systems and methods are applicable to other types of media files and other media viewers or players. Accordingly, the term eBook will be used in describing the methods and systems herein synonymously with a medial file, and the term eBook reader will be used synonymously with a media viewer and/or media player. The eBook reader is any device that can display written material in an electronic format. The eBook reader can therefore be a specific eBook reader, such as a Kindle, Sony Reader, etc., or a general purpose device with eBook reader software, such as a laptop, iPad, smart phone, etc. As used herein, an eBook provider is generally the party that provides eBooks at a retail level to other parties, such as subscribers and recipients. The subscriber is generally the party that shares its eBooks in the limited manner disclosed herein with recipients. Recipients are the parties that receive the eBook from the subscriber and/or provider with geographic and/or temporal limitations defined by the subscriber.

Generally speaking, the subscriber purchases or otherwise obtains subscriptions to certain eBooks, such as magazines, or other media files that the subscriber wants to share with its customers or potential customers. The subscriber can therefore limit the subscription so that the eBooks are used only in the geographic area of the subscriber's offices and/or within the subscriber's normal business hours. For example, a doctor may provide e-magazines to his or her patients while they are waiting to see him or her. Similarly, an airline may provide eBooks to its passengers while they are waiting for a flight or while in they are in flight. Customers may be allowed to take the eBook or portions thereof (the “eBook Material”) with them or have the eBook or portions thereof emailed to themselves, for example, if they have not finished reading an article. In this instance, the location and/or time limitations are enforced at the beginning of the exchange and preferably for some time thereafter. That is, the recipient may be required to be in the specific location and/or within the time limit to receive the eBook Material, and may have to be at the location for a period of time, e.g., for at least 20, 30, 40, etc. minutes before the recipient can take or have the eBook Material emailed to them.

The limits may be enforced in many ways. For example, the eBook reader may be set up so that if it is removed from the predefined location, the device locks itself from all use and it may only be unlocked, e.g., with an encrypted key, at the specific location. The device may unlock itself automatically when it is taken back to the specified location. This embodiment may be implemented when the reader, such as a Kindle, is provided to the recipient by the subscriber for use in the subscriber's location.

Recipients may also use their own eBook readers. In this instance, the eBook will preferably be the primary way to enforce restrictions. For example, the reader may include software that will allow the recipient to download the subscribed eBook Material to the device only when the device is in the specified location and/or at the specified time. The device may include an interface that displays the subscribed content available, based on the location and/or time. In this instance, the recipient may select the content to be downloaded to the device. The content downloaded may also include the subscription limitations specified by the subscriber, which will be used to enforce those limitations. For example, the content may include a location limitation that will disable the eBook when the device is not in the limited area. The eBook may include a link therein that allows the recipient to purchase the eBook Material without the limitation.

The subscriber may not be required to have any special equipment for the service. That is, the present system may be implemented with existing infrastructure. In this instance, the subscriber may be provided an interface, such as a website, where the subscriber can specify eBook content and the location and/or time limitations if any. The subscriber may also be given options with regard to marketing material that may be available, such as pamphlets and other material relevant to the subscriber's practice. After the subscriber defines the subscription in terms of content and limitations, the subscriber may simply post a sign in the location informing recipients that content is available for download via a specific portal onto their device. The sign may include a key and/or other information, such as the subscriber's information, for customers to use to access the content authorized by the subscriber. This will ensure that the content will not be available to users that do not at least visit the subscriber location. They key may also be generated for the specific customer. For example, at the doctor's office a different key may be assigned to each patient. The key may be linked to the patient's account, which would allow the patient to view the patient's own records, etc. The key may be generated at the point of sale. For example, a key may be generated on the receipt when the customer purchases coffee at a coffee shop. The key generated may be one of a plurality of keys set aside for the subscriber, or the key generated locally may be uploaded to the content server for verification. The content may thereafter be downloaded from the service provider and viewed with existing software or with an application that allows users to view the downloaded content and enforce the limitations. Alternatively or additionally, the subscriber may provide a wireless node that recipients can use to download content and to enforce restrictions.

The location and/or time may be determined in a variety of ways. For example, this information may be obtained with location services associated with the device, such as GPS. The location and/or time of non-GPS enabled eBook reader devices may be determined readily from the proximity of the devices to a plurality of transmitter and/or receiver sites with which the device is capable of communicating, such as cell phone towers, WiFi hotspots, other mobile devices, etc., or a combination thereof, and with common triangulation techniques or collaborative localization. As another example, an SMS Text message with instant and accurate time stamp may be used to determine the time, returning a link that can be clicked for location-based access in 15 minute-blocks, and renews as long as the connection remains unbroken within the space.

The system may also be used to provide targeted advertising to recipients. In one embodiment, the eBook includes a predefined space for advertising that is inserted therein on demand. For example, a magazine may include a predefined rectangle for advertisements. The eBook itself does not necessarily include an advertisement. Rather, advertising content is preferably placed therein at some later time, such as when the eBook is being requested for download. The advertisement may be a graphic object with or without a link to the advertiser's webpage. The system may then determine the appropriate advertising, based on the eBook content and/or on the requester's predefined demographics, e.g., age, gender, interests, geographic location, etc., create a fixed eBook, and communicate the eBook with the advertisements placed therein to the requesting recipient. The advertisements themselves may also have a limited life. For example, the advertisements may expire and be replaced on the device with other advertisements. The advertisements may also be relevant to the subscriber's services. For example, a plastic surgeon may have subscription to e-magazines with advertisements to collagen injections. Similarly, specialized newsletters published pursuant to that practice's specialty may also be provided.

The device may also interface with the subscriber's appointment/record system to provide specific information to the recipient and allow the user to update information therein. For example, the system may share records, test results, and prescriptions locally and securely. The device, such as a Kindle, may be pre-loaded based on expected appointments for the day and the device may be handed out only to the specific patient. The device and information are preferably HIPA compliant, and information exchanged is preferably subject to HIPA restrictions on distribution or sharing. . HIPA protections may be enhanced by biometric security, such as fingerprints.

The reader may also be used as a “Virtual Clipboard” for check-in and communication of patient or other histories. Patient histories, for example, may be available as encrypted files with “restore points,” so that the patient may be given the opportunity to verify the accuracy of the data as of that date at each new medical visit, but will not necessarily need to recapitulate the patient's full medical history, e.g., through four pages of yes/no questions. With each new check-in at a doctor's office, the patient is asked to verify new information as to treatments, diagnoses, medications, and any other information since the prior restore point for the patient's record, in addition to current insurance information. The patient's record may be maintained at the practice, may be maintained by the insurance company, or may, for example, be maintained by any future record-keeping software or record-keeping entity, so as to be available for the patient to provide at the time of any medical visit. The patient verifies that information is current as of that date and the record may then be released to the physician. The record may preferably be released in segments, e.g. to diagnostic software, to the practice's patient record software and the insurance co. software can record the visit, record the report, cross reference medications, charge the visit to the patient and submit the visit to insurance company. The information that is released is limited to that which the condition requires, or which the doctor requests. Patients are aided in communicating information they may have forgotten or that they may be reluctant to share, while the doctor is ensured that the data set he requires is provided in as complete a form as possible, and that supplemental questions requiring answers may be more rapidly identified.

The present application provides a device with multiple, e.g., four or more displays with touch screen surfaces. Each display may be disposed on an individual display section. The display sections themselves are preferably hinged to each other side by side similar to that of a laptop computer. That is, the four displays may be linked end to end to form a W shape when folded. There may be a rotational pivoting at a corner of the central sections permitting the central hinge to be separated and the sections rotated 90 degrees toward the other to form a square surface such as, for example, a gaming board. One or preferably a plurality of the screen sections includes a sensor that recognizes the configuration of the folds. For example, the device may recognize that it is folded into an L shape, a C shape, Z shape, etc. The device thereby sets its primary function based on its configuration. For example, in an L shape, the device may emulate a laptop whereas in a fully folded W shape, the device may emulate an eBook reader or a PDA. In a completely unfolded configuration, the device may emulate an HD TV or other media device.

The hinge design may vary, however, the hinge is preferably recessed in such a matter so that hinge is not visible at least when the devices is open fully and preferably so that the seam between the sections is barely visible if at all in at least this configuration.

The display screens may vary. For example, some or all of the displays may be LCD displays, ink screen displays, or other flat, thin displays. The screen sections may each have multiple screens. For example, multiples of the same type or different types of displays may be disposed on one or both sides of a section, or as at least one display on each side of a screen section. Any combination of such displays may preferably be configured among various potential embodiments, according to desired functionality. The display sections may be hinged in this respect with non-display sections, such as a section that provides a physical keyboard. In addition, one or more of the screens may be a combination display, such as an ink display portion combined with a portion with backlighting to allow high definition graphics to be presented on the touch screen and/or text to be presented on non-backlit ink-type displays portions. In another configuration two or more ink screens may be situated on the four sides that may be viewed contiguously.

In one embodiment, in place of conventional laptops' single internal screen and single internal keyboard, the device will have two display sections hinged at one end. The device will include two internal screens and the two outer screens. When closed, either exterior screen can function as the single display for a tablet-type computer or display device. The device can include a sensor that determines the orientation of the device and/or the screen sections and may be set so that whichever screen is facing up will be the active screen.

The device may have an instant on capability to permit basic computing to be done without opening the device further to the laptop configuration. That is, the remaining devices that would be emulated may be cached to allow the device to be accessed essentially instantly as the configuration and/or orientation is changed.

When opened, the device may recognize that it has changed configuration again and will become a laptop, with a full Qwerty touch screen keyboard and touchpad area in place of an analog keyboard and touch pad, and a full display panel above, as in a laptop, and also able to function as s touch screen. In this configuration, the exterior screen on the back of the computer screen can also be set to become an active display, aiding in presentations. Each section may also include a projector to further aid in presentations and a speaker.

When opened all the way, so that both open halves are flat, the device will recognize the position and emulate a single, large, high definition display, with a choice of several functions. Movies or videos or art may be viewed in this widescreen format, similar to a 21-inch 16:9 aspect ratio monitor. With the touch screen functionality, the device may also serve as a wide tabletop display or extra-wide tablet computer. The touch screen functionality also permits the wide, flat display to be used as a sketch pad or drafting surface using a tap cursor (which may have a sleeve in the unit). The large flat configuration may also be used to display an entire page of a newspaper. In one embodiment the device may be configured with ink screens one side of the device so that when it is laid flat in and of the available conformations, on all the surfaces that will be visible when the device is laid flat in any of the available formations, to facilitate the presentation of electronic content in the large format of a newspaper. In one embodiment such contiguous display screens may be populated with content as a single image or display, and the device may permit paging through such displays in a manner similar to paging through a newspaper. In another embodiment the device may preferably have four display screens that may be configured flat lengthwise or as a square, to permit electronic gaming including traditional board games such as chess or backgammon. In another configuration the device may be folded as an inverted “T” to permit opposition gaming by two players. The device may have rear projection means for displaying graphics from the rear of the display section.

The display may be propped to stand essentially vertically. In this instance, both sides of the device may be active and display common or different content. For example, one side may display one movie while another displays a different movie. In term of aiding presentations, one side may display an image directed at the audience while another side displays an interface for the person addressing the audience. For example, the presenter may have access to the complete functions of a computer, including a word processing program, slide show, media player, etc. that the presenter uses for the presentation. On the opposite end, the device will display only the end product that the presenter wants the audience to view. For example, the interface for the presenter may display all of the slides of presentation, selectable and editable individually. In this instance, the opposite may only display the particular slide that the presenter selects for the audience. Alternatively or additionally, the presentation may be displayed via the projector instead of the opposite end of the device.

When folded open but not all the way and set on its ends such that the spine is vertical, the folded computer may recognize that it is a book reader, and permit the presentation of reading material with two facing pages, similar to the presentation of a book. This configuration may be remembered, for example, with an input from the user so that the display will not change functionality if it is resumed to a flat or any other position. Custom configurations may be designed that would use all four screens at once or any combination desired by the user.

Each screen section may include its own processing power, e.g., processor, memory, graphics card, etc. for the specific device that the particular screen section emulates. The processing power may be combined when multiple screen sections are used. For example, when the device emulates a PDA or smart phone, using a single display, the device may use the processing power of the screen section being used for the emulation. Similarly, if the device emulates a laptop or tablet PC, the device may combine the processing power of two or more of the screens being used for the emulation. Each display may also include other components or share components with other screens. For example, each or a plurality of the sections may each include a digital camera, Wifi or other wireless communications equipment, etc. One or more sections may also include a sensor for sampling a user's biometrics, such as fingerprints, face or iris recognition, etc. In one embodiment, the display, in addition to displaying visual images, also serves as the biometric sensor. For example, a portion of the display may depict a keyboard or other input device. That portion of the display may include a sensor, such as a fingerprint sensor, that confirms the user's identity as the user inputs data into the device via the touch screen. The sensor is preferably disposed within the display so that the sensor is essentially imperceptible. In one embodiment such touch screen biometrics may be used, in lieu of a password, to encrypt digital files to prevent their being opened by any but authorized users, including in cases where the device itself is not locked by biometrics.

Exterior screens may have replaceable transparent outer layers to preserve functionality as widescreen HD viewers or tablets even if scratched.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A system comprising at least one computing device coupled over a network to a plurality of ebook readers, the at least one computing device having software associated therewith that when executed causes the at least one computing device to perform a method comprising:
receiving a request for an electronic file in an ebook format from a recipient user of at least one of the ebook readers;
determining a location of the at least one ebook reader and a time of the request for the file;
determining that the location and the time of the request is within a location and time specified by a subscriber other than the user; and
providing access to the file based on the location and the time of the request.

2. The system of claim 1, the method comprising: determining that the device has moved out of the location specified by the subscriber and blocking access to the file in response thereto.

3. The system of claim 1 the method comprising: determining that the device has moved out of the location specified by the subscriber and blocking access to the file in response thereto a predetermined time after the device has moved out of the location.

4. The system of claim 3, the method comprising: communicating an offer to the user of the device to subscribe to the file.

5. The system of claim 1, wherein the subscriber provides a service at the location and the recipient user is provided access to the file in conjunction with the service.

6. The system of claim 5, wherein the ebook is a magazine.

7. The system of claim 5, wherein the ebook is a pamphlet relevant to the service provided by the subscriber.

8. The system of claim 5, wherein location is determined based on a key made available at the location.

9. The system of claim 8, wherein the subscriber provides a unique key for each of a plurality of users.

10. The system of claim 5, wherein the user has an appointment for a service provided by the subscriber and the file is made available within a period of time before and after the appointment.
